(19) United States
(12) Patent Application Publication
(10) Pub. No.: US 2002/0059137 A1
(43) Pub. Date: May 16, 2002

(54) Online mortgate application processing and tracking system

(76) Inventors: Douglas K. Freeman, Jacksonville, FL (US); Gart Davis, Chapel Hill, NC (US); Richard Martin Linn, Portland, OR (US); James Paul Gross, Columbia, SC (US); Chip S. Register, Irmo, SC (US); Rhonda K. Cottingham, Columbia, SC (US); Kathleen L. McDivitt, Honolulu, HI (US); Melinda D. Jones, Irmo, SC (US); Scott A. Buchanan, Salt Lake City, UT (US); Akin Agar, Columbia, SC (US)

Correspondence Address: MICHAEL A MANN, NEXSEN PRUET JACOBS & POLLARD LLC, PO DRWR 2426, COLUMBIA, SC, 29202-2426, US

(21) Appl. No.: 09/893,029

(22) Filed: Jun. 27, 2001

Related U.S. Application Data
(60) Provisional application No. 60/214,767, filed on Jun. 27, 2000.

(51) Int. Cl. G06F 17/60

(52) U.S. Cl. 705/38

(57) ABSTRACT

An online mortgage application processing system that allows a mortgage originator to upload mortgage loan application data and then have the loan application processed through registration of the loan, underwriting, locking the loan rate and ultimately to the transfer of funds and completion of the preparation and assembly of the documentation for loan closing, via a secure web site. The originator can use the web site to track multiple loan applications and efficiently control their processing and, because the web site permits communication between the loan application originator and the lender, permits issues that develop during processing to be quickly and effectively addressed. The system uses an electronic file to maintain a consistent set of loan application data for both the originator and lender to use in processing the loan and facilitates the incorporation of paper copies of documents into the electronic file where they can be inspected. The system also permits the originator to meet the various requirements for closing, including obtaining various types of insurance and having certificates evidencing that insurance available in the electronic file. Finally, the system allows the lender to offer to the originator a selection of appropriate mortgage loan products and related products that might be of interest to the borrower.

### PRIORITY CLAIM

The Applicants claim the benefit of the filing of US provisional patent application serial number 60/214,767, filed 06/27/2000, which is incorporated herein by reference.

### FIELD OF THE INVENTION

The present invention relates generally to electronic commerce. More specifically, the present invention relates to the processing and tracking of mortgage loan applications for mortgage brokers and correspondents via a web site.

### BACKGROUND OF THE INVENTION

Beginning in the late 1990's, there has been explosive growth in the use of the internet, which is a world wide system of computers interconnected by telephone lines and communication protocols. While much of this use is largely for information and entertainment, a growing segment of it is now facilitating the transaction of business. Companies are finding that they can communicate and transact business with their customers, suppliers, distributors, and agents quickly and effectively via the internet rather than through traditional channels. However, knowing that the internet could facilitate business transactions and deciding what form those transactions should take are two very different matters.

While some sectors of commerce have quickly embraced the business use of the internet, others have moved more slowly. For example, the mortgage brokerage industry has not moved as aggressively as other industries to harness the power of e-commerce. One potential reason for this hesitancy is the fragmented nature of the industry.

While many mortgages are placed by large companies, approximately 70% of the $1.7 trillion dollars worth of home loans in 1998 originated with the 36,000 mortgage brokers in the United States. A typical mortgage broker is a small, independent business. Mortgage brokers use contacts within a community to find potential borrowers, who they then match up with lenders. Each broker will have access to numerous lenders, each lender offering different loan programs (often called “products”) to the public. In some states there are regulations requiring a minimum level of training for mortgage brokers; in others, there are no requirements. Accordingly, the level of sophistication in the conduct of business varies significantly.

A mortgage broker facilitates the transaction between lenders and borrowers. A mortgage “correspondent” is an organization that is not a broker, and may have the net worth to place loans itself, but may operate as a broker from time to time. Small banks are typically correspondents. For convenience, the term “mortgage originator” or “originator” will be used when referring to both mortgage brokers and correspondents.

The mortgage loan transaction is dominated by paperwork. It centers around forms and documents containing information from and about the borrower, and about the property the borrower proposes to buy, that the lender requires to evaluate the loan application. These documents are stored in files and sent between originators and lenders, by mail or by facsimile. These documents are needed to process the request for a loan. Typically various concerns arise along the way that need to be addressed over the telephone or through the mail system.

For example, the process may proceed as follows. A borrower may call the mortgage originator and request the originator to arrange a mortgage loan. The borrower will provide information to the originator that will be entered by the originator manually by keystrokes into a computer programmed with a software application. The information will be sent, typically by facsimile, to a mortgage lender where it will be checked for completeness and then given a loan registration number. The loan application will be submitted for underwriting and its progress tracked by both the lender and the originator. The originator will have to place a telephone call to the lender in order to determine its status at every step of the process.

Underwriting is the process of evaluating the information supplied by the borrower to determine if the loan can be made or at what interest rate it can be made. Sometimes a conditional approval is given at this stage. For final approval, the borrower must furnish documentation intended to verify the statements made on the loan application, such as a W-2 form and a bank statement. If the documentation does not support the information given, the preliminary indication that the loan would be give may have to change, additional conditions may be imposed or the rate may change.

In the event of discrepancies between the information as originally given and as documented, the documents may have to be re-generated and resubmitted. Once everything is in order, the loan rate is locked and closing of the loan is scheduled. (Loan rates may be locked at any time.) Until the loan rate is locked, and the lender is committed to providing the loan at the locked rate, the rate will float with the market. Typically, closing is not scheduled less than 48 hours from the time the loan is locked and the funds are requested. Potentially, however, loan rates may be locked up to 45 days prior to closing.

In addition to providing the service of helping the borrower through the loan application process, mortgage originators can help borrowers find specific loan products that meet their needs better than other loan products. Mortgage brokers generally have access to more programs than the neighborhood bank. Different lenders have different requirements and some products will have conditions that some borrowers can meet but others cannot. By reviewing the various loan products and the associated terms and conditions attached to these products from many lenders, the mortgage originator can try to find a product that has the combination of terms and price that suits the borrower best. This is a time consuming task, especially since the products available are constantly changing.

Some aspects of mortgage lending have achieved a level of automation. For example, underwriting has been automated since the early 1990s. Two of the automated underwriting systems, those offered by Fannie Mae (a program called DESKTOP UNDERWRITER® or DU) and by Freddie Mac (a program called LOAN PROSPECTOR® or LP), account for 95% of the total market. These programs typically consider factors such as equity, credit history and liquid reserves plus other factors, that are weighted and then combined to produce a finding.

Consumers, instead of going to banks or mortgage originators, can shop for mortgages online. Although currently, less than 1% of all mortgages—about $4 billion dollars' worth—are obtained over the internet, this number is expected to increase dramatically. Some consumers find online shopping for mortgages to be more convenient and more cost-effective. Usually, the consumer fills out a loan application form online and then receives a package of paper forms to complete a day or two later in the mail. After completing the forms and assembling required documentation such as pay stubs and bank statements, the consumer mails them back to the lender for processing. Consumers are kept informed of the status of the processing of their loans, including the appraisal and verification of information provided, using the internet or email. These types of online mortgage processing web sites are called processor sites. Other current processor sites include IOWN.COM, MORTGAGE.COM, E-LOAN.COM, KEYSTROKE.COM, and INTERLOAN.COM.

Other websites that consumers look to for mortgages are called referral sites. At a referral web site, loan applications are taken on line but then are then referred to a lender who proceeds to process the loan in the traditional way. Sites that currently operate in this fashion include HOMEADVISOR.COM, IQUALIFY.COM, THELENDINGTREE.COM, AND QUICKENMORTGAGE.COM.

The mortgage loan application process is heavily dependent on the use of paper, telephones and facsimile machines. Forms are often completed by hand; redundant files are kept by various parties involved in the transaction; and information is conveyed by telephone and facsimile machines. Even computer use in processing loans currently requires the same information to be re-entered manually by various parties. It can also be stressful for the consumer, the mortgage originator and the employees of the lender when the process fails to run smoothly. Thus, there remains a need for a more effective way to process loan applications for mortgage originators.

### SUMMARY OF THE INVENTION

According to its major aspects and briefly recited, the present invention is an online mortgage application processing system that allows a mortgage originator to upload mortgage loan application data and then have the application processed from that point through registration of the loan, underwriting, locking the loan and ultimately to the transfer of finds for loan closing, via a secure web site. The originator can use the web site to track multiple loan applications and, because the web site permits communication between the originator and the lender, enables the originator to address more effectively the issues that inevitably develop during processing.

The originator can upload paper copies of documents by facsimile to the system for storage with an electronic file. These document images are associated with other information pertinent to the borrower's loan for the lender's and originator's inspection. Their receipt by the system is immediately evident to the mortgage originator. The system also permits the originator to download closing documents and order credit reports, appraisals, and mortgage, title and flood insurance. No part of the process need take place through the postal system or by voice over the telephone; all the information regarding the loan is available on the web site to those authorized. Finally, once data is entered or changed, all other entries affected by that entry or change are adjusted automatically to avoid re-entering the same data twice or forgetting to change information on each of the affected forms.

The present system also makes it possible to present a full range of appropriate products including new mortgage products to the originator for consideration. Because the system can store and evaluate hundreds of products against the borrower's circumstances, it can filter out those that are not appropriate and present all those that remain with their various advantages. The originator does not have to rely on memory to know what products will fit a borrower's needs.

A major advantage of the present system is that it provides a single, controlled source of information in electronic format on all loans being handled by both the mortgage originators and the mortgage lender, and, importantly, all the departments of the lender who may need to have access to that data. Thus, everyone involved in processing the loan uses the same, complete set of information. Data entry requirements, errors and miscommunication are dramatically reduced, making all parties more productive.

Another major feature of the present invention, which will be elaborated upon below, is the presentation of the information. The presentation includes both the web site informational architecture as well as the graphical appearance of it. The presentation simplifies locating and understanding the information as well as the processing of the loan.

The ability to upload, edit, download, register, lock and underwrite loans electronically is still another major feature of the present invention. This ability greatly simplifies the effort required for—and cost associated with—the processing of loans and shortens cycle time. No documents need to be mailed; no telephone calls (and return calls) need to be placed. The web site is available at all times, including after normal business hours and during business hours in different time zones and on weekends and holidays and from anywhere from which internet access is possible.

Another feature of the present invention is the simplification of data entry. Once the loan information is keyed into the originator's system, regardless of the origination system used, it need not be re-keyed, which has the effect of reducing the incidence of errors and increasing the speed of processing. If an error has been made in entering the data initially, correcting it is simplified and, if the error is in entering a number that affects calculations related to the loan, entry of a new number automatically causes the system to recalculate all other affected numbers. Furthermore, data entered once is used to populate forms where the same data is required so that only new entries need be made. For example, the borrower's name and address and telephone number, once keyed in by the loan originator into its own origination application, never need to be entered into any loan document again. Productivity is increased and errors are reduced.

Another important feature of the present invention is that the status of all loan applications can be checked on line at a glance. This capability allows a originator to determine status without the need to review individual paper files or to make telephone calls. This reduces loan application costs and increases productivity. Not only can status be checked for every loan as soon as the user logs on, but the system automatically generates email messages (or alternatively, facsimile messages) notifying the mortgage originator of the underwriting decision or other circumstances requiring immediate attention.

Still another advantage of the present system is that it standardizes a significant part of the mortgage lending process. With over 36,000 mortgage brokers, including many with limited experience and training, the quality of the “paperwork” from them understandably varies greatly. Standardization improves the quality of all the information being used, especially the closing documents. The present system makes the process a more efficient experience for the borrowers because it collects the information in one place, the information is consistent, discrepancies are found, in many cases automatically, and resolved prior to closing.

These and numerous other features and their advantages will be apparent to those skilled in the art of the mortgage financing industry from a careful reading of the Detailed Description of Preferred Embodiments, accompanied by the Following Drawings.

### BRIEF DESCRIPTION OF THE DRAWINGS

In the drawings,

FIG. 1 is a schematic illustration of a system for processing mortgage loan applications according to a preferred embodiment of the present invention;

FIG. 2 is a screen shot of a standard lender's home page of a web site for processing mortgage loan applications, according to a preferred embodiment of the present invention;

FIG. 3 is a screen shot of a personalized home page of a web site for processing mortgage loan applications, according to a preferred embodiment of the present invention;

FIG. 4A and 4B illustrate an example of a pipeline page of a mortgage loan application processing system; according to a preferred embodiment of the present invention;

FIG. 5 is an example of a 1003 form for processing a mortgage loan application, according to a preferred embodiment of the present invention; and

FIG. 6 is a Underwriting Decision Sheet page as seen by an internal underwriter for a mortgage loan application processing system, according to a preferred embodiment of the present invention.

### DETAILED DESCRIPTION OF PREFERRED EMBODIMENTS

The present invention is an online mortgage loan application processing and tracking system. The system includes the hardware and software that enables a user to access a web site via the user's browser and to use the site to apply for and fund mortgage loans. In this context, “online” means that the system is accessible and usable via the internet, an intranet, an extranet or other computer network using standard telecommunications links. In the case of an intranet or extranet, the telecommunications links are established and maintained by the user for the benefit of the mortgage originators with which it does business. Telecommunications links include ordinary telephone lines, T-1 lines, fiber optic cable, cellular and other currently used, or subsequently developed, means for accessing a computer network.

The system employs a dynamic web site that includes a data base and enabling software, and that is linked via the use of hypertext markup language and world wide web protocols internally and externally to other web sites so that the user can navigate through the site to find information and access its various features and information available at other sites.

The home page, easily accessed by pointing the user's browser to the web site's universal resource locator (URL or domain name), is public. However, the balance of the web site is accessible only to those authorized by contract to do so. Authorized users are assigned passwords and user identification codes (often referred to as USERIDs) and the system uses 128 bit encryption or encryption standards equivalent to those used by commercial banks to maintain the confidentiality of the information exchanged. In addition, a private network not connected to the internet could be used in addition to or in lieu of the conventional security measures currently used in connection with web sites.

Once having logged onto the secure portion of the web site, the user is at a main window that includes various “buttons”, “pop up” windows and “pull down” menus that the permit the user to navigate the site and both provide and obtain information. The basic technology that is used in creating and operating web sites—databases, web site programming languages, object-based programming, “buttons”, “pop up windows”, “dialog boxes”, navigation bars, and the well known operations required to operate a computer programmed with object-based programming—clicking, pointing and entering data in dialog boxes—, are not part of the present invention and are all well known. Rather, the present invention is directed to how this technology is employed, the combinations of features, the type of information and features selected for inclusion in the combination, and the site informational and graphic architecture.

The user interface described herein consists of web pages running on the user's browser, which is preferably a current version of any of the most commonly used internet browsers. The user's screen resolution should be 800×600 or higher and have a color depth of 16 bits or more.

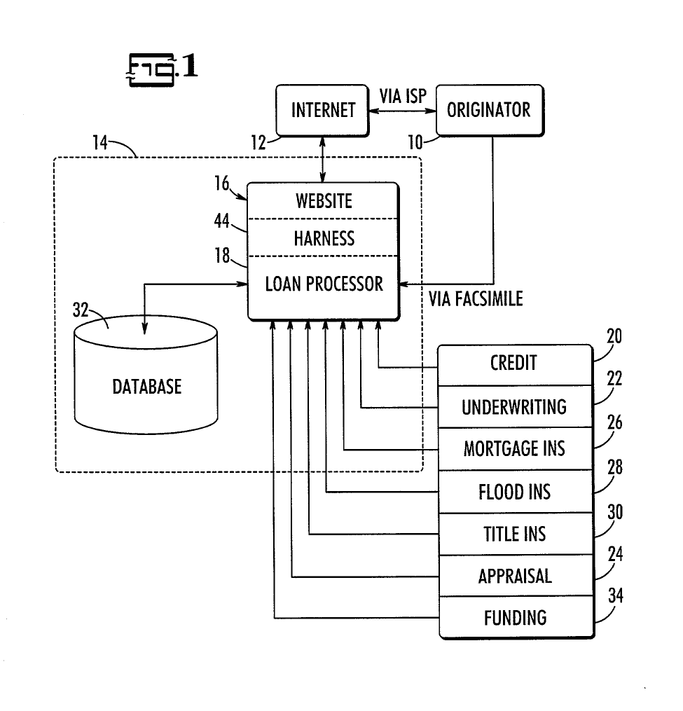

FIG. 1 illustrates schematically the overall architecture of the present system. The customer, namely, a mortgage originator 10, accesses the present system 14 via the internet 12 using its browser. From the website 16, it can use a loan processor 18 to apply for a loan, have the loan processed, track the loan, and obtain the funding for the loan, in addition to ordering various services such as credit reports 20, underwriting 22, appraisal reports 24 and insurance such as mortgage 26, flood 28 and title insurance 30 that are relevant to the complete lending transaction. Information is accumulated and stored in a database 32. When requested by originator 10, the loan can be funded by a funding source 34 via electronic fund transfer.

The mortgage originator typically enters mortgage loan application data into its local computer which has been programmed with loan origination software (LOS). There are many such programs and the present invention is designed to accommodate all of the major ones. An example of a common version of LOS is the program CONTOUR. This step, namely entering loan application data manually into a computer using the LOS, is not part of the present invention in all of its preferred embodiments; nor is the present invention dependent on the mortgage originator having LOS or a particular brand of LOS. As will be described, loan application data may be keyed in directly, without the need for loan origination software.

The mortgage originator 10 uses its internet browser to access the system 14 via the internet 12. The present system 14 is linked to Fannie Mae's DESKTOP UNDERWRITER® (DU) and Freddie Mac's LOAN PROSPECTOR® (LP) for automated underwriting 22, to credit bureaus for credit reports 20, real estate appraisal companies for appraisal reports 24, and to various insurance providers for mortgage 26, title 30 and flood insurance 28 coverage. Loan processing is available from loan processor 16 via a harness 44 to the web site 16 that allows the “front end” software or web site application software, to communicate with the “back end” software or loan processing software, as will be described herein. At the back end, registration numbers are assigned to each loan application, the loan application can be validated, underwritten, the rate locked and the loan funded, perhaps by electronic fund transfer. Images of documents needed for meeting underwriting conditions are sent to the system by originator 10, using a facsimile machine or equivalent, where they are associated as images with the loan application file and displayed to originator 10 accessing the web site.

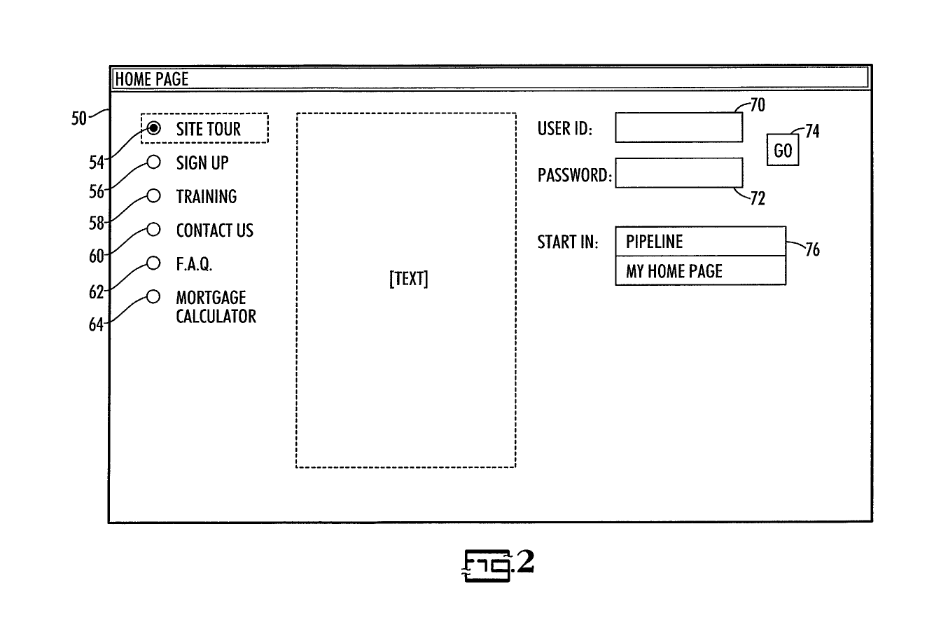

FIG. 2 illustrates a simplified home webpage 50 of the present web site. Webpage 50 may be accessed by any member of the public and contains both general information 52 and, through hyperlinks, special information such as a site tour 54, provisions for a sign up 56 of new originators, training 58 of originators, contact information 60 and frequently asked questions (FAQ) 62 and their answers. Webpage 50 may potentially have useful features such as a mortgage calculator 64.

From home page 50, the user enters a USER ID in a first dialog box 70 and a PASSWORD in a second dialog box 72. The user then clicks on the GO button 74 to access the starting page 80, which may be the page showing the pipeline or a customized starting page (“My Homepage”). The selection of starting page is made by clicking on the user's choice in the START IN dialog box 76 to highlight it. The START IN page or starting page 80 contains information useful to the user, such as contact information 82, market information 84, news about mortgage information 86, basic mortgage product information 88 and pipeline summary or list of loan applications undergoing processing 90. The user may alter the content of this page with an edit feature 92.

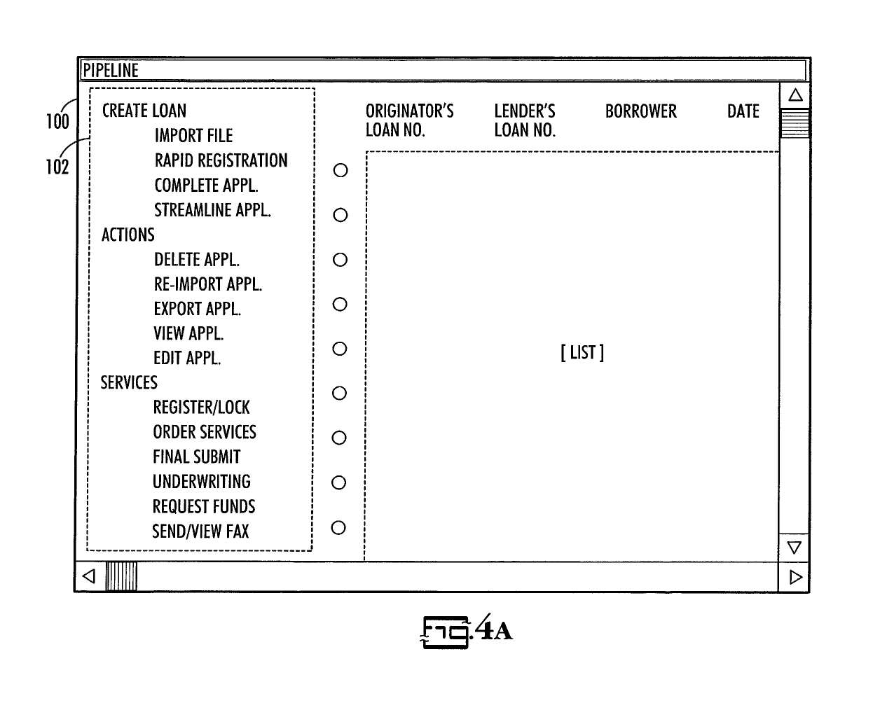

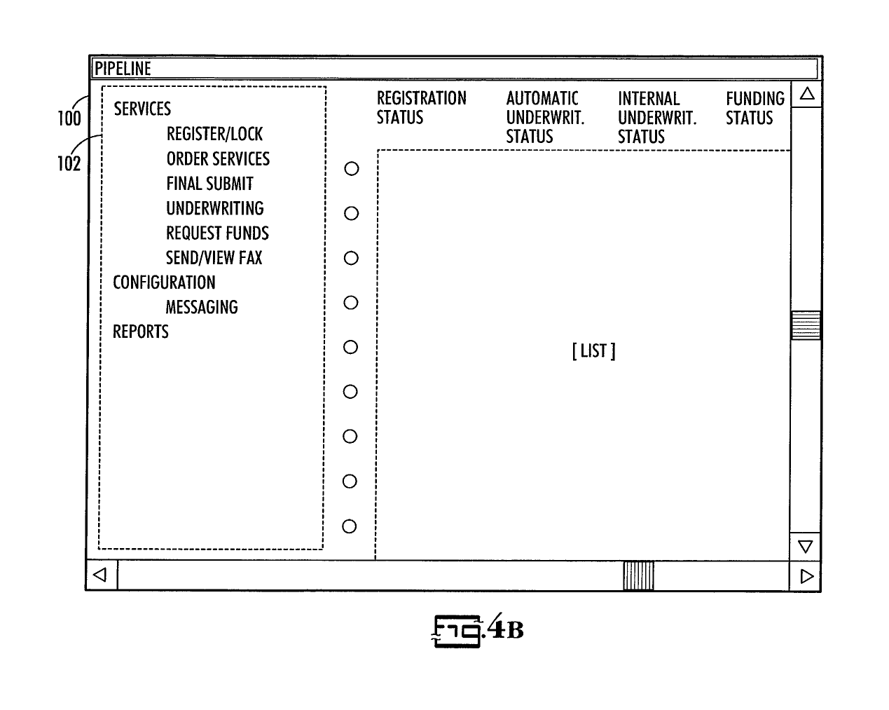

Alternatively, the originator may go directly to the “pipeline” page 100 (FIGS. 4A and 4B) to check the status of the various loan applications in the pipeline. The term “pipeline” is simply a metaphor for a series of loan applications entered into the present system for processing by a particular originator. The applications may in fact all be entered at approximately one time or at irregular intervals. Furthermore, loan applications entered later may be processed more quickly than others, so there is no implication in the use of the term “pipeline” that the first one in the “pipeline” is going to be the first one processed to completion.

FIGS. 4A and 4B together illustrate overlapping portions of a pipeline page which shows all of the user's loan applications in progress and the status of each loan. Pipeline page 100 is an important feature of the present invention. By scrolling up and down and side-to-side, the user sees in the pipeline page at a glance all loan applications that apply to that user, based on the user's USERID and PASSWORD. Thus the user is able to quickly and immediately check the status of each loan application every time the user logs on.

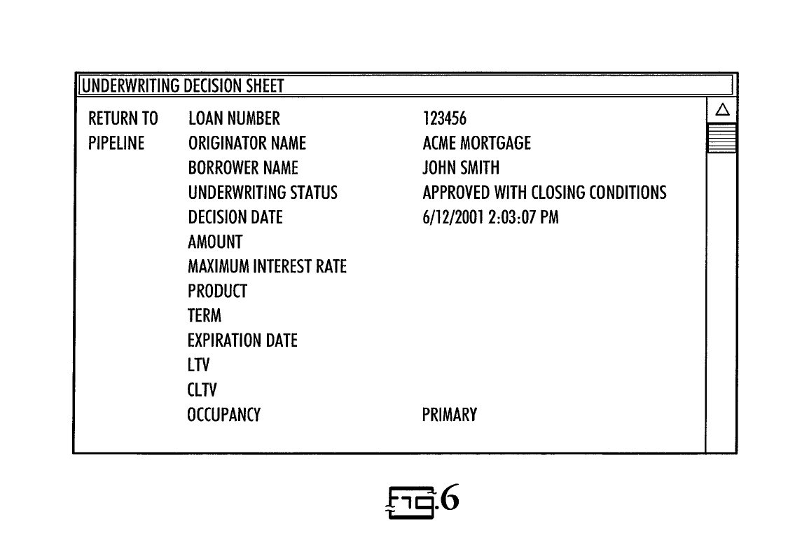

Loan applications can be organized on pipeline page 100 in various ways, at the discretion of the user (the loan originator) depending on preference. For example, they may be listed by the name of the borrower or by the loan application number. The originator may look for a particular loan by using a search function or simply scanning down the list of pending applications. Furthermore, the originator may select a different algorithm for sorting the applications for the listing. Details of each loan are obtained by clicking directly on a particular loan, which links the loan listing to a “LOAN DETAILS” page, FIG. 6.

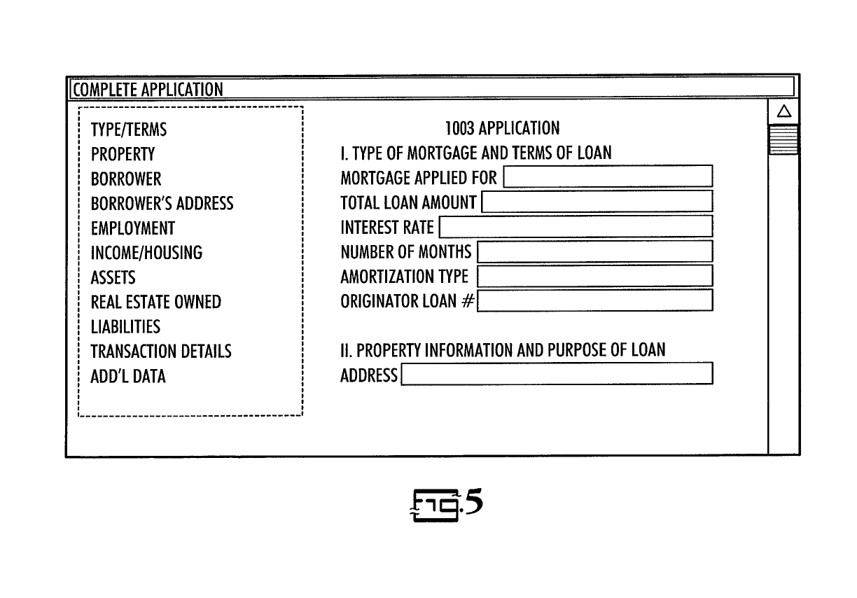

The pipeline page includes a navigation bar 102 that includes a series of menu items. The navigation bar 102 allows the user to navigate to other pages with other features and information relevant to each specific loan. Navigation bar 102 reappears on each page hyperlinked to pipeline page 100. From navigation bar 102 on pipeline page 100, various actions or services can be performed by selecting the corresponding button marked with an action/service listed in the menu. The main menu items include the following: CREATE LOAN, ACTIONS, SERVICES, CONFIGURATION, and REPORTS. CREATE LOAN allows a user to import a loan file or partially or completely input loan application data. “COMPLETE APPLICATION”, as a choice under CREATE LOAN, takes the user to “form 1003” loan application page 108 (FIG. 5) where data regarding a new loan can be entered by key strokes (1003 is a standard form used in the mortgage lending industry).

In order to import loan application data from the user's loan origination database, the user selects “IMPORT FILE” from the CREATE LOAN choice on menu bar 102, which permits the user to upload loan application data from the user's own loan origination database stored on the user's computer and which was previously entered using the loan origination software installed on it. The originator merely supplies to the present system the location of the file to be uploaded and authorizes the importation of that file. From the user's data, full form 1003 data or, if preferred, an abbreviated set can be entered in order to obtain a more rapid registration or proceed more quickly to underwriting.

The originator will in most cases be using loan origination software that allows her to key in data at her own computer, which saves that data to a file on the originator's hard drive. The data includes much or all of the information needed to complete a standard 1003 form, standard for loan applications in the mortgage industry (FIG. 5). The loan origination software is designed to allow the originator to print out a completed 1003 form or transmit the electronic version of the form to another computer. However, various manufacturers of loan origination software format the 1003 data in different ways.

When the user clicks on the IMPORT LOAN, an import page appears with a dialog box wherein the user enters the file number of the loan application data from the user's loan origination software. If the originator wishes to enter a new loan application for processing, she enters the file location and authorizes the import. Otherwise, loan application can be keyed directly into boxes adjacent to each type of information sought. In some cases pull down menus are provided to prompt the user as to the type and range of information to be input or to obtain standard responses (such as standard two-letter state codes).

The remaining items under CREATE LOAN in navigation bar 102, RAPID REGISTRATION and STREAMLINE APPLICATION, also allow the user to key data directly into the system but require less data. The user will also be able to change the 1003 data, whether keyed in directly or imported, for underwriting purposes. (Users can not change “lock” data, however There are two separate sets of data, one for lock and one for underwriting. These data sets are compared before the request for funds is granted to verify they match.) The STREAMLINE APPLICATION requires only the data set for submitting the file to an underwriter.

Various other, administrative actions are available under the ACTIONS item, including DELETE APPLICATION, RE-IMPORT APPLICATION, EXPORT APPLICATION, VIEW APPLICATION and EDIT APPLICATION which are self-explanatory and help the originator manage a portfolio of applications. If a user wishes to download loan application data, the EXPORT APPLICATION action from navigation bar 102 permits this. The data will be downloaded in a file format compatible with any one of a set of standard loan origination software programs (such as CONTOUR and DESKTOP ORIGINATOR) that the originator might use to generate data for its loan origination database. A user can also edit loan data by clicking on the borrower's last name or selecting the button and then selecting “EDIT APPLICATION” from the actions menu bar.

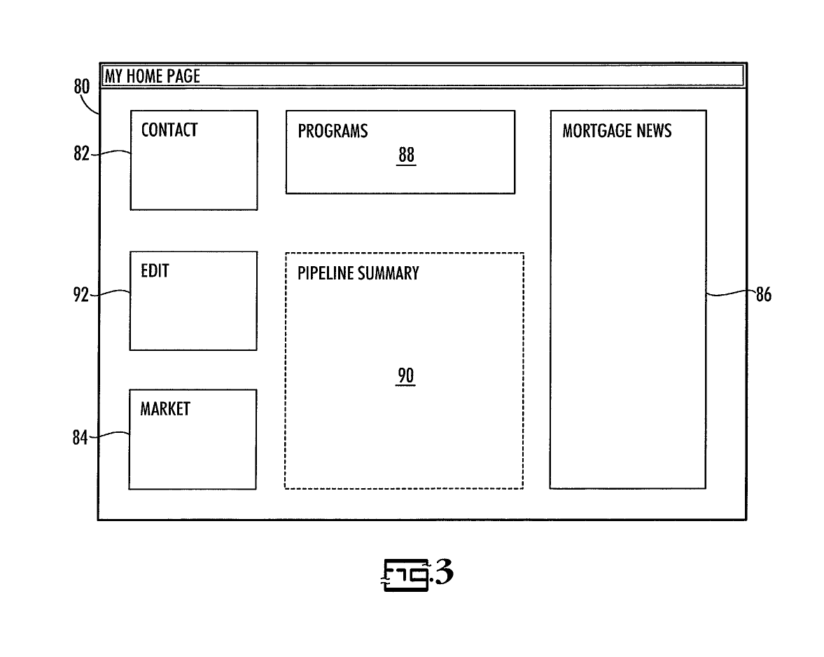

Elsewhere on navigation bar 102 of pipeline page 100 is the SERVICE item on navigation bar 102 (FIG. 3). Navigation bar 102 also includes the following: REGISTER/LOCK, ORDER SERVICES, FINAL SUBMIT, UNDERWRITING, REQUEST FUNDS, and SEND/VIEW FAX. The REGISTER/LOCK button allows the user to register and lock the loan application data. Through the REGISTER/LOCK choice, the user can create a lock quickly by supplying only the loan application fields necessary to register and lock a loan. The ORDER SERVICES button enables the user to request various documents, such as credit reports from credit bureaus and underwriting reports such as DESKTOP LNDERWRITER® reports and LOAN PROSPECTORS® reports from FANNIE MAE and FREDDIE MAC, respectively. The present system is linked to these outsourced services over a network.

The CONFIGURATION button enables the user to set alerts. Alerts are messages sent to the originator. Without the receipt of an alert, the originator might not know of an event until she logs onto the site. An event might include a generic event such as a change in interest rates, or a specific event such as the approval of a loan for a specific customer. The CONFIGURATION button will allow a user to define what events are to be messaged and how alerts are to be sent: by facsimile, by email or by pager, or by a combination of all three.

When a loan application or other related data has been entered, either by importing it or keying the data, the present system uses the data to populate all fields in all parts of a mortgage loan application file employing hypertext markup language (HTML). If there are errors in the data, a message will be sent to the user. Otherwise, the originator will see the data displayed on the web site for confirmation as soon as it is entered. The originator can change information directly on the web page and then save the data (via EDIT APPLICATION) when satisfied that the data are correct.

The originator can stop there or can continue processing. If she elects to continue, she will order a credit report and automated underwriting. The credit report is a prerequisite for automated underwriting because it contains valuable information on the borrower's history of paying bills. Underwriting is a process of predicting the likelihood that the borrower will be able to regularly and timely meet the obligations of the loan in view of the borrower's other payment obligations. This prediction is based on information about the borrower's credit history and about the proposed transaction and on algorithms established by the underwriter. Those algorithms may vary from time to time based on the experience of the underwriter.

From the navigation bar 102, under SERVICES and UNDERWRITING the user selects DESKTOP UNDERWRITERS® drop down box (or other automated underwriting application, as will be described below), and a CREDIT REPORT button from SERVICES to obtain a credit report on the borrower for submission to DESKTOP UNDERWRITERS® for underwriting. The credit report and the underwriting report are available from other web sites, are “outsourced” by the present invention but need not be if the present system is set up to provide credit reporting and underwriting directly. However, the accessing of these sites and the obtaining of the credit reports and underwriting are automatically accomplished by the present invention because of its programming and the results entered onto the detail page within a few minutes.

There are numerous credit bureaus that currently provide credit reports for a nominal fee. These can be accessed, usually on line, to obtain the credit report needed before underwriting can be done. For automated underwriting, there are two major automated underwriting programs: DESKTOP UNDERWRITER® by Fannie Mae and LOAN PROSPECTOR® by Freddie Mac, both available on line. These two organizations are government sponsored enterprises. Although underwriting requires a credit report beforehand, both DESKTOP UNDERWRITER® and LOAN PROSPECTORS® provide these services when automated underwriting is requested. Specifically, the user of the present system does not have to request and obtain a credit report beforehand in order to request underwriting. By requesting underwriting, the user will cause the underwriting software to obtain a credit report from one of the credit bureaus Fannie Mae and Freddie Mac have relationships with. Access to credit bureaus and these two automated underwriting programs is performed automatically, via the internet, by the present system.

The status of the loan on the detail page changes when the underwriting report comes back The status may be “approve/eligible” “approve/ineligible”, “refer with caution” (in one of four categories) by Fannie Mae's DESKTOP UNDERWRITER®. Other programs have different designations. The words “eligible” and “ineligible” indicate whether the borrower is eligible or ineligible for a Fannie Mae loan. The findings of the underwriting and the credit report can be viewed in cases where the loan is not approved or if it is referred with caution to determine if the obstacle to obtaining loan approval can be solved.

By clicking on “FINAL SUBMIT” on navigation bar 102 on pipeline page 100, the user can submit a file with documentation. These documents, such as bank statements, pay stubs, verification of employment are usually available in paper form to the borrower and can be furnished to the mortgage originator. The originator sends them by facsimile to the lender. In order to link faxed documents with the electronic file, a cover sheet that has an identifier number is required. That identifier number enables the present system to bring the documents into the system by facsimile and connect them to the electronic file. The cover sheet is downloaded by the mortgage originator from the web site using the SEND/VIEW FAX button on navigation bar 102, and then used to associate the documents faxed back to the system with the corresponding loan. The receipt of the faxed documents is indicated in the LOAN DETAIL page. By clicking on each document, the lender and the mortgage originator can see a full sized image of the document can be inspected (but not edited) to confirm that the documents have been received, are legible and are complete. Documents that are received in other than normal orientation can be rotated electronically so that the underwriter can view them in the normal orientation.

The lender then underwrites the loan by logging the electronic file out, and clicking on the loan. The page that then appears to the lender has a hyperlink to an image of the faxed document and the loan information. Each document can be inspected by clicking on it to enlarge it for comparison to the 1003. As each condition is met, it is cleared by clicking in the appropriate box. Once all conditions are cleared, the lender submits the loan application for approval. If approved, the mortgage originator receives an email confirming that the loan has been approved and the associated conditions of approval.

Either before or after obtaining the results of automated underwriting, the user may want to register a loan. Registration is performed simply as a prelude to processing a loan application and is a matter of assigning a tracking number to the loan application. To receive a registration number, a portion of the data in the loan application information is transferred to loan processing software such as iLOAN, a software application available from Alltel. To register the loan application, the REGISTER/LOCK menu item is clicked and the originator may also want to submit the loan application for final approval.

Before the loan can be approved, the loan originator needs to validate the loan. In order to validate a loan, the originator collects documents from the borrower and other sources (for example, verification of employment, a pay stub, and a bank statements). These are sent by facsimile to the lender where they are imaged and attached to electronic file automatically, as will be described below. Once received, they are identified as “submitted” to the originator who can see the images of the transmitted documents on the web site. The lender validates the loan application by comparing it to the loan criteria.

During the processing of a loan application, data must be transferred between the “front end” and the “back end” of the present system. The “front end” is the end that contains the user interface which is a web site; the “back end” stores and manipulates data. To facilitate this transfer, the web site must be harnessed electronically to the “back end” of the present invention. The back end includes the loan application processing software. The web site application and loan processing application exchange information and requests via the harness. Using this harness, an originator can take the data set that has already been submitted to an automated underwriting engine, and cross apply the data to register the loan using the loan processing application software. The originator can then review the lender's rates for the loan based on the pricing stored in the loan processing software database and apply for a loan rate lock. The harness takes the data set that the originator has submitted and validates it against the rules that the lender has programmed into the loan processing software and validates that the loan application meets those rules. The originator then either receives confirmation that the loan application has been validated or a validation error. The user is thus able to control the loan processing via the web site, seeing the results of the processing of the loan application framed in the pages of the web site.

In an effective website that allows one business to interact with another business (here the originator and the lender), the former needs to have a clearly defined set of transaction methods with which to initiate transactions and receive results. This requirement is often met by creating a set of transaction methods, then writing code to support these methods in the implementation of the transaction directly into the internal system using the functions and designs dictated by the internal system.

However the problem created by using this approach occurs when the internal system on which the site is based changes. The methods of implementation must be modified or totally rewritten using new functions and designs as required by the new internal system. The result is the use of resources to implement the new system, or loss of functionality of the website, or both. Also, this method of implementation does not provide for reuse of the code or application when a similar site may need to be created.

To avoid this inefficiency, the present invention accommodates this functionality through multiple layers of the application. These layers have different functions and serve to insulate and isolate the customer interface layer from the system layer so that changes to the internal system can be implemented without rewriting functions from the customer's interface to the web site as a result of changes to the internal system.

The three layers are the “integration layer,” the “business layer,” and the “software infrastructure layer.” The integration layer is the customer interface layer and provides high level mapping of the data and transaction request. Data as received from the customer typically requires both product mapping and possibly also translation from the customer format to that used by the internal system. This layer provides these product and customer mapping functions.

The business layer carries the functionality of the web site that the customer is expecting to find for processing and tracking loans. These functions include, loan registration and lock, loan pricing, product validation, underwriting decisions, rate sheet publication, and event/status notification. Designers of the website must understand the functions that are required and how those functions are performed. The functions performed by the website must have well-defined and consistently-used parameters so that the customer can request the transaction with all the necessary data to complete the transaction and obtain an appropriate response. Also, not all the functions of this layer needs to be programmed into the website coding. There may exist other functions that may be available via an interface with other external systems (“outsourced” functions), such as, for example, underwriting, credit checking, and obtaining flood and title insurance. The transaction with these outsourced functions appear to the customer as if they are part of the internal system.

The software infrastructure layer is the third level of code that provides base interaction with the internal system. The functions at this level include the ability to access and retrieve information from the database, messaging, workflow, and imaging. At this level, the code will be impacted if the internal system is changed or replaced. The business layer makes request for services to the software infrastructure layer that then uses native functions, newly written customer functions or base data access methods to perform a transaction.

Among the transactions that take place using an informational and request exchange between the web site application and the loan processing application, in addition to the registration of the loan, are locking in a loan rate, submitting a loan application for final approval, requesting funding and requesting other services that will allow the loan to close.

When a loan application has been submitted to the lender, the response is not necessarily a singular one (“approved/eligible”, “approved/ineligible” and “refer with caution”). The response may take either or both of two forms. The first form may be a list of types of loan “products” the borrower may be qualified for (all for which the borrower is “approved/eligible”). The second may be the rates at which the lender will provide a loan to a particular borrower for the particular products offered by the lender and the borrower's circumstances (again, all for which the borrower is “approved/eligible”). This latter form is termed “risk based” pricing. The term “product” means a set of general terms associated with a loan agreement. For example, one loan product may be a 30-year fixed rate mortgage. Another may be a 15-year adjustable rate mortgage. Additional details in the general terms may expand these two examples into numerous products. For example, an adjustable rate mortgage may be capped in terms of how much the rate can be adjusted upwardly or downwardly or the amount of down payment made may affect interest rate or eligibility.

Different products have relative advantages for the borrower, the originator and the lender. By listing plural products for each borrower, the present invention makes it easier for the originator to make recommendations to the borrower.

Currently, originators may be familiar with a few to a few dozen products and be capable of sifting through the products of which they are familiar. However, the present invention enables the originator to receive the results of a sifting of scores or hundreds of products to find those most suited to the needs and financial abilities of the borrower. Furthermore, because the present system is capable of accumulating the experiences of huge numbers of borrowers and originators, it is possible to use this information by “data mining” to design new mortgage products that better suit the needs of a changing marketplace and use the present invention to more efficiently and effectively bring those new products to the attention of originators rather than depend on traditional advertising and marketing techniques.

The present invention includes the capability of providing an assortment of products to the originator using a “Product Switch.” The switch operates by capturing information about a borrower and the borrower's requirements from the input information and other information obtained about the borrower. It then analyzes the borrower's requirements in view of the various mortgage products to determine if there is additional information about a borrower that is needed to determine if the borrower qualifies for a product. Once all of the information needed has been obtained, a set of suitable mortgage products are identified. These products are then scored based on the borrower's cost, the originator's revenue, and the lender's net value added factors (such as low propensity to prepay, low processing costs, etc.). Next, the candidate products are evaluated and, by applying arbitrary cutoff rules, those which are the best for the borrower and best for the lender are preserved and the remainder eliminated. The surviving products are ranked in order of advantage for the originator. Finally, if there are other products outside of mortgage products that might be of interest to the borrower, such as life insurance or credit cards, these are associated with the surviving products.

Next, the loan applicant's data is submitted to automated underwriting to qualify the borrower for each candidate product. The products for which the borrower is qualified are presented to the originator along with any additional, non-mortgage products. The originator may elect one of the products or revise the initial data and go through the process again. Once a suitable selection is made by the originator, the selection is captured in the form of a loan application registration and the loan application for that product goes forward to the underwriting process.

Risk-based pricing is performed so that practically any borrower can obtain a mortgage provided that the return to the lender takes into account the relative risk of lending to that borrower. Using algorithms, the lender can adjust the rate up or down depending on risk. The present invention incorporates various types of mortgage loan products for automatic implementation by the back end loan processing application that will provide the originator with a range of products to offer the borrower.

A loan rate is locked for the loan application when the originator selects a rate from the set of possible offered by the lender. The loan rate selected corresponds to a product and an expiration date. If the rate expires, the lender's obligation to provide that rate expires with it, but the lender is bound until that date. When the originator selects a rate for locking, the present application returns a confirmation message to the originator.

When the loan application is submitted for final approval, it must undergo underwriting a second time. Although a preliminary indication of whether the loan will be approved is provided by automated underwriting, the party providing the loan may want to impose its own conditions on the loan in addition to those indicated in automated underwriting. The final underwriting can be done based on a locked loan rate or a floating rate, i.e., one that floats with the market.

Although underwriting is largely accomplished in a traditional way, there are several important differences provided by the present invention. One important difference is that the underwriting is done without paper. The loan application submitted for underwriting appears in a queue of “virtual” loan application folders for an underwriter to address, i.e., the loan applications are all in digital, electronic form with hyperlinks to the various pages contained in the application “folder.” When that loan application listing is opened (by clicking on the loan registration number, which is hyperlinked to the electronic file), all of the relevant information is available to the underwriter (FIG. 6). The underwriter can examine the information and compare it to that provided by the borrower and identify any discrepancies and ask any questions needed to approve the loan.

In addition to the examination of the loan application by the underwriter, a software-based automatic comparison is done to identify discrepancies between the information used for automated underwriting and the information submitted for final approval from the loan register and loan rate lock database. There are a number of reasons why the information from these two sources might not match. Underwriting data can be changed before or even after the loan rate is locked. Because the user can lock the loan after the application has been submitted for final underwriting and approval, underwriting data can be changed even after final approval so there can be mismatches at a number of different times in the process prior to funding the loan. This comparison is done whenever underwriting data is changed, usually within moments, so that any discrepancies are brought to the attention of the user, who can then resolve the apparent discrepancies in order to assure that data critical to loan pricing are the same as those used for automated underwriting by the time funding is requested.

The results of underwriting are usually subject to conditions. These conditions will be imposed on the borrower and are typically satisfied by producing documentary evidence to the lender. For example, the borrower may need to supply a W-2 form as proof of income. The user can send that document to the present system by facsimile in such a way that it will be linked up with the balance of the electronic file, as described above.

The underwriter can then proceed to inspect the documents for their completeness and content to determine if they satisfy the conditions imposed as a result of the underwriting process. The conditions of each loan are listed in the electronic file. As each condition is satisfied, the electronic file is marked to indicate that the condition has been satisfied, typically by clicking on a button which causes it to change its appearance, indicating at a glance that the condition has been satisfied.

Various “events” occur during processing that trigger an automatic email function. The email is sent by the system to the user when the event is important enough to bring it to the user's attention. Alternatively, the user may be notified by facsimile and by electronic pager. Loan approval, rate lock or discrepancies found during underwriting are events, for example.

When a loan application has been submitted for automated underwriting, the results are reviewed automatically by the present invention to determine if the loan application is likely to be favorably viewed when submitted for a final review. Certain factors may make it likely to be approved and other factors may make it a more difficult loan to process or less likely to be approved. For example, a low debt to income ratio is a factor that favors approval; recently declaring bankruptcy will raise questions about how long it will take or even whether a loan will be approved. The data file from automated underwriting is scoured for the factors that affect the ease of loan approval. Those loan applications that will more than likely be approved will qualify for a simpler processing procedure called “rapid validation”. When such a loan application is detected, the user is notified along with the receipt of the results of automated underwriting.

When all the conditions have been satisfied and the loan rate has been locked, the user may want to request funding. In order to request funding the user will submit an electronic fund request that provides the present system with mortgage insurance information such as the mortgage insurance company name, type of mortgage insurance, and the amount financed; flood insurance information such as the name of the mapping company, the community participation date, the contract type and the flood zone; disbursement information, such as the closing date, the disbursement date, the title insurance company, and confirmation that an insured closing letter is on file; and wire instructions, such as the name of the recipient bank, the bank telephone number and bank ABA number. Electronic fund request 120 is automatically completed from data stored in the loan processing application except for additional information particular to the funding transfer. This additional information typically includes the contact name, telephone number and address and account number of the party receiving the funds and the decision as to whether the funds are to be forwarded by electronic fund transfer or by check. This request is confirmed promptly. Electronic fund transfer makes the funds available on the next business day.

There are other services that can be ordered in much the same manner as a credit report and automated underwriting. These other services include all those needed in order to complete the loan application processing so that the loan can close, including obtaining an appraisal and various types of insurance such as mortgage insurance, flood insurance and title insurance. Not only can these services be ordered via the present web site but the associated documentation such as certificates of insurance and appraisal reports, can be received electronically, from vendors of these services, and immediately associated with the loan application file for printing out by the originator in time for closing.

The term “appraisal” is used not only to describe the process of determining the market value for a home, but also, in a larger sense, to provide assurance to the lender that, in the event of a default, the loaned amount is recovered. In the more traditional sense of the word appraisal, the borrower obtains an evaluation of the value of the property. In the larger sense, the lender obtains insurance that guarantees that the loan will be recovered in the event the value of the property less expenses for selling it are less than the remaining balance on the loan.

Furthermore, the evaluation of the property may be a detailed on performed by a specialist and based on comparisons with similar homes in the area, or may be much more informal, at the discretion of the lender.

Because of the amount of data, and the need to have it accessible by a number of users simultaneously. A storage area network will be used to store the data on servers separate from the loan processing network and accessible to the loan processing software application and web site software applications. A storage area network allows growth in the storage capability without loss of continuity in service.

There are a number of advantages of the present system. First, once data are uploaded from loan origination software or by manual entry, that data do not have to be reentered or written by hand or typed onto any loan related form. Furthermore, both the user and the lender are using the same data. Second, the user has a great deal of control over the process and can track loans through the process to know instantly the status of each loan application. Third, the user can initiate a number of steps in the process whenever ready. Fourth, all the unproductive aspects of traditional mortgage loan processing: the administrative inconvenience, the limitations and expense of communicating via telephone, routine mail delivery, overnight mail delivery, and facsimile, and the manual logging of data and completing forms, and the potential for miscommunication between loan processing departments, is substantially reduced or eliminated. Sixth, the originator can manage a loan application portfolio while away from the office as long as the originator has access to the internet and a computer. Seventh, information regarding events of importance to the originator are conveyed by email automatically without relying on someone to initiate them.

It will be apparent to those skilled in the are of mortgage financing and electronic commerce than many changes and substitution may be made in the forgoing preferred embodiments without departing from the spirit and scope of the present invention, defined by the appended claims.

What is claimed is:

1. A system for processing mortgage loan application data, said system comprising:
a web site adapted for receiving a set of mortgage loan application data;
an internal system having a database an a computer, said database responsive to said computer and said computer programmed to process said set of mortgage loan application data;
means for harnessing said web site to said internal system so that a user can access said internal system to have said computer process said set of mortgage loan application data.

2. The system as recited in claim 1, wherein said computer can process plural sets of mortgage application data in parallel, and further comprising means for displaying simultaneously the status of each set of mortgage loan application data submitted by said user for processing.

3. The system as recited in claim 1, wherein said computer is programmed to respond to a request by said user for payment of mortgage funds and said web site is adapted to enable said user to request payment of said mortgage funds.

4. The system as recited in claim 1, wherein said internal system is linked to a source of insurance so that said user can apply for insurance from said source of insurance.

5. The system as recited in claim 4, wherein said insurance selected from the group consisting of mortgage insurance, title insurance and flood insurance.

6. The system as recited in claim 4, wherein said internal system is adapted to receive an image of a certificate from said source of insurance and associating said image of said certificate with said mortgage loan application data.

7. The system as recited in claim 1, wherein said internal system is adapted to receive an image of a document transmitted by facsimile and associating said image of said document with said mortgage loan application data.

8. The system as recited in claim 1, wherein said internal system is linked to a source of a report and adapted to receive a report from said source of said report and associating said report with said mortgage loan application data.

9. The system as recited in claim 1, wherein said report is selected from the group consisting of a credit report, an appraisal report, and an automatic underwriting report.

10. The system as recited in claim 1, wherein said internal system generates messages to said user to notify said user of an event.

11. The system as recited in claim 1, wherein said database contains plural mortgage products and corresponding criteria, and wherein said computer is adapted to identify a set of mortgage products from said plural mortgage products for which said mortgage loan application data meet said corresponding criteria.

12. A method for processing mortgage loan application data, said method comprising the steps of:
providing a web site adapted to interface with a loan originator and to enable uploading a set of mortgage loan application data and a request for mortgage funds from said loan originator;
storing said uploaded set of mortgage loan application data received from said user in a database;
ordering via a computer over a computer network a credit report on said mortgage loan application data stored in said database;
ordering via said computer over said computer network an underwriting report on said set of mortgage loan application data stored in said database;
approving a mortgage loan based on said set of mortgage loan application data stored in said database, said credit report and said underwriting report;
notifying said loan originator electronically of said approval of said mortgage loan; and
electronically transferring said funds in response to a request by said loan originator.

13. The method as recited in claim 12, further comprising means for receiving documents by facsimile from said loan originator and associating said documents with said mortgage loan application data.

14. The method as recited in claim 12, further comprising providing a connection via said computer network to a source of insurance so that said loan originator can apply for said insurance from said source.

15. The method as recited in claim 12, wherein said approving step further comprises the steps of offering to said loan originator a list of mortgage loan products for which said mortgage loan application data are qualified.

16. The method as recited in claim 12, further comprising the step of ordering an appraisal report via said computer over said network and associating said appraisal report with said mortgage loan application data.

17. A method for processing mortgage loan application data, said method comprising the steps of:
accessing a web site adapted to interface with a loan originator;
uploading via said web site a set of mortgage loan application data;
ordering via a web site over a computer network a credit report on said mortgage loan application data stored in said database;
ordering via said web site over said computer network an underwriting report on said set of mortgage loan application data stored in said database;
requesting via said web site over a computer network approval of a mortgage loan based on said set of mortgage loan application data stored in said database, said credit report and said underwriting report; and
requesting via said web site mortgage funds for said approved mortgage loan from said loan originator via said computer over said computer network.

18. The method as recited in claim 17, further comprising the step of ordering insurance via said web site.

19. The method as recited in claim 17, further comprising the step of ordering an appraisal report via said web site.

20. The method as recited in claim 17, further comprising the step of making, via said website over a computer network, a selection of a mortgage loan from a list of mortgage loan products for which said mortgage loan application data are qualified.
